(19) United States
(12) Patent Application Publication
(10) Pub. No.: US 2025/0332659 A1
(43) Pub. Date: Oct. 30, 2025

(54) Ranging Systems For Laser-Welding Tools, and Related Systems and Methods for Laser Welding on Workpieces

(71) Applicant: SES (Shanghai) Co., Ltd., Shanghai (CN)

(72) Inventors: Yong Duan, Shanghai (CN); LuYong Shen, Shanghai (CN); Zhongzong Teng, Shanghai (CN)

(21) Appl. No.: 18/658,637

(22) Filed: May 8, 2024

(30) Foreign Application Priority Data
Apr. 25, 2024 (CN) 2024105132848

(51) Int. Cl. B23K 26/03; B23K 26/042

(52) U.S. Cl. CPC B23K 26/032; B23K 26/042

(57) ABSTRACT

Ranging systems for laser-welding tools that include laser-based ranging devices that are moved into and out of a corresponding beam envelop that contains one or more laser-welding beams for making welds. In some embodiments, a ranging system of this disclosure includes a coupling mechanism for coupling one or more ranging devices to a laser-welding tool, wherein the coupling mechanism alternatingly moves the ranging device(s) from a welding position to a ranging position or allows the ranging device(s) to be alternatingly moved between such positions. Ranging systems of this disclosure obtain accurate and precise ranging distances that contribute to precisely locating a focus spot of each laser-welding beam relative to each welding location so as to minimize the occurrence of mis-formed weld from improper focus spot locations. Laser-welding systems incorporating such ranging systems and related methods of forming welds are also disclosed.

### FIELD

The present disclosure generally relates to the field of welding. In particular, the present disclosure is directed to ranging systems for laser-welding tools, and related systems and methods for laser welding on workpieces.

### BACKGROUND

Secondary battery cells typically include stacked cores composed of alternatingly stacked cathodes and anodes electrically separated from one another, with the cathodes electrically connected to a cathode cell-output tab and the anodes electrically connected to an anode cell-output tab. These cells are often used to make multi-cell battery modules in which multiple battery cells are arranged in a stack and adjacent ones of the cell-output tabs are electrically and physically connected to one another. Often, these connections are made by welding the cell-output tabs together by laser welding.

Laser welding requires that the focus spot of the laser beam that creates the weld be precisely located, in terms of distance, from the laser-welding tool. If the distance is not correct for creating the necessary focus spot, then the weld created can be defective from either overheating or underheating, as the case may be. A challenge arises in the laser-welding process because there is some variability in the welding location, again in terms of distance from the laser-welding tool, due to any one or more of a variety of factors, including, but not limited to, imprecise bending of the cell-output tabs that creates the well regions, imprecise locating of the cell stack within the welding fixture, and repeatability errors of any robotic manipulator that locates the cell stack for the welding process, among others. Errors in distance as small as 1 mm to 2 mm can result in suboptimal welds.

To ensure quality weld, it is necessary to ensure that the distance between the laser-welding tool and the region(s) on the cell-output tabs to be welded is optimal, because the location of the laser spot of the welding beam relative to the welding location is critical for making a quality weld. However, there is no convenient and precise way to make the necessary measurements to confirm/set that distance. Most methods rely on taking manual measurements. However, manual measurements can easily result in errors of 1 mm or more.

### SUMMARY

In one implementation, the present disclosure is directed to a ranging system for use with a laser-welding tool that is used to make a weld on a workpiece at a welding location by emitting a welding beam along a beam path. The ranging system includes a ranging device designed and configured to determine a ranging distance to the welding location when the ranging system is deployed and being used during welding operations; and a coupling mechanism designed and configured to couple the ranging device in a fixed relationship relative to the laser-welding tool so that: when the ranging device is determining the ranging distance, at least a portion of the ranging device is located in a ranging position in the beam path; and when the laser-welding tool is emitting the welding beam so as to make the weld, the ranging device is located in a welding position out of the beam path.

In another implementation, the present disclosure is directed to a laser-welding system, which includes a laser-welding tool that is used to make a weld on a workpiece at a welding location by emitting a welding beam along a beam path; and a ranging system that includes: a ranging device designed and configured to determine a ranging distance to the welding location when the ranging system is being used during welding operations; and a coupling mechanism designed and configured to couple the ranging device in a fixed relationship relative to the laser-welding tool so that: when the ranging device is determining the ranging distance, at least a portion of the ranging device is located in a ranging position in the beam path; and when the laser-welding tool is emitting the welding beam so as to make the weld, the ranging device is located in a welding position out of the beam path.

In still another implementation, the present disclosure is directed to a method of determining a ranging distance to a welding location for making a laser weld on a workpiece with a laser-welding beam having a beam path. The method includes moving a ranging device into the beam path; while the ranging device is in the beam path, operating the ranging device to acquire the ranging distance; and after acquiring the ranging distance, moving the ranging device out of the beam path.

In another implementation, the present disclosure is directed to a method of making a laser weld on a workpiece with a laser-welding beam having a beam path. The method includes moving a ranging device into the beam path; while the ranging device is in the beam path, operating the ranging device to acquire a ranging distance to a welding location on the workpiece; after acquiring the ranging distance, moving the ranging device out of the beam path; and after moving the ranging device out of the beam path, causing the laser-welding beam to make the laser weld on the workpiece.

### BRIEF DESCRIPTION OF THE DRAWINGS

For the purpose of illustration, the accompanying drawings show aspects of one or more embodiments of the disclosure. However, it should be understood that the scope of this disclosure is/are not limited to the precise arrangements and instrumentalities shown in the drawings, wherein:

FIG. 1 is a partial high-level block diagram/partial schematic view of an example laser-welding system made in accordance with aspects of the present disclosure;

FIG. 2 is an isometric view of an example laser-welding system configured to weld electrical tabs of electrochemical cells in assembling a secondary battery core (workpiece), wherein the laser-welding system includes an example ranging system that accurately and precisely measures one or more distances from the laser-welding tool to the workpiece; and

FIG. 3A is an enlarged front view of the workpiece of FIG. 2 and corresponding welding fixture, showing example inspection spots where the ranging system acquires ranging data;

FIG. 3B is an isometric view of the laser-welding system of FIG. 2 without the ranging system added, showing an example laser-welding tool and the workpiece to be welded; and

FIG. 4 is an enlarged view of the example laser-ranging system of FIG. 2.

### DETAILED DESCRIPTION

The entire contents of the appended claims are incorporated into this Detailed Description section by reference and should be treated as if originally presented herein.

### General

In some aspects, this disclosure is directed to ranging systems that can be used with a laser-welding tool to precisely determine one or more welding distances from the laser-welding tool to a workpiece in order to accurately set the focus spot(s) of one or more laser beams that make(s) the corresponding weld(s) on the workpiece. As used herein and in the appended claims, the term “welding distance” and like terms denote a distance between a laser-welding tool and a welding location on the workpiece to be welded that is the distance between the laser-welding tool and the welding location needed to optimize the focus-spot location of the laser beam at the welding location that will lead to making a good weld. The welding distance can be the distance between the welding location and any suitable reference location, such as a location on the ranging device or a location on the welding tool, that can be used to determine that the focus spot location substantially coincides with the welding location.

As discussed below, a ranging system of the present disclosure includes at least one degree of freedom for moving a ranging device into and out of a welding-beam path of the laser-welding tool in order to obtain highly accurate ranging data relating to the welding distance that is substantially along the beam path(s) of the laser-welding tool. As also discussed below, ranging systems of the present disclosure can be provided with one or more additional degrees of freedom to accommodate various adjustments, such as one or more adjustments for achieving differing focus-spot locations and one or more adjustments for locating the ranging device in a plane perpendicular to the beam axis of the welding tool. In the below examples, the workpiece is a stack of secondary battery cells on which the cell-output tabs of adjacent pairs of the cells are welded so as to electrically and physically connect them to one another. However, in other examples, the workpiece can be virtually any object that requires at least one laser-formed weld, or “laser weld.”

In some aspects, the present disclosure is directed to methods of determining a ranging distance that is located substantially along a beam path of a laser-welding tool by moving a ranging device into and out of a welding-beam envelope of the laser-welding tool. The moving of the ranging device may be accomplished in any suitable manner, such as by linear or curvilinear translation of the ranging device or by pivoting the ranging device, or a combination of translation and pivoting, among others. Such a method may further include operating the ranging system to measure a ranged distance and then using the ranged distance to determine a welding distance. In some embodiments, the ranging distance is the welding distance. In some embodiment, the welding distance is equal to the sum of the ranging distance and a predetermined distance, such as a distance between a location of the ranging device and a location on the laser-welding tool. Some methods of the present disclosure may further include adjusting the location of the ranging device to accommodate differing laser focal lengths (e.g. when using the ranging system with differing laser-welding tools). Some methods of the present disclosure may further include adjusting the location of the ranging device in one or more directions perpendicular to the nominal beam path of the welding-beam envelope. In some aspects, the present disclosure is directed to methods of forming a laser weld using a ranging system of the present disclosure. The foregoing and other aspects are exemplified below and/or in the appended claims.

### EXAMPLE EMBODIMENTS

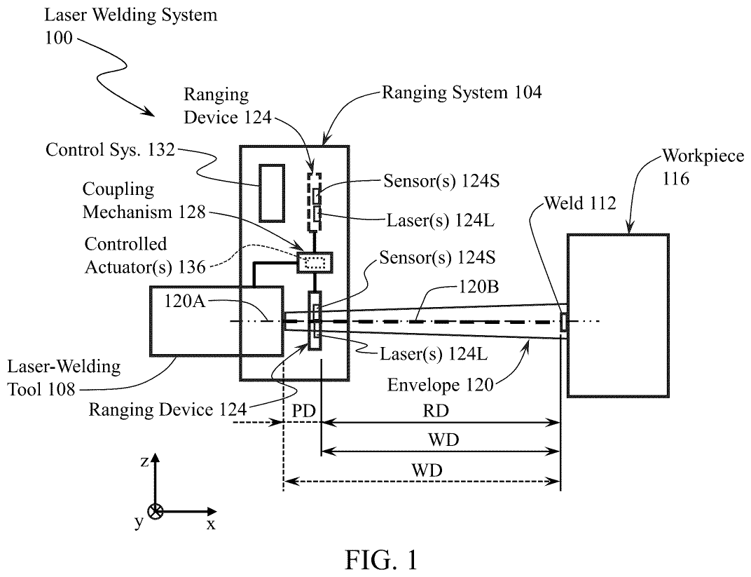

Turning now to the drawings, FIG. 1 illustrates an example laser-welding system 100 of the present disclosure. In this example, the laser-welding system 100 includes a ranging system 104 and a laser-welding tool 108 that are used to form a laser weld 112 on a workpiece 116, which, as noted above, can be any suitable workpiece, including a stack of electrochemical cells for forming a secondary battery, among many other things. The laser-welding tool 108 can be any suitable laser-welding tool for creating laser welds, such as the laser weld 112. Those skilled in the art will be familiar with both to-be-welded objects suitable for the workpiece 116 and laser-welding tools suitable for use as the laser-welding tool 108 such that further explanation is not needed for them to appreciate the broad scope of the present disclosure.

In this example, the laser-welding tool 108 has a laser-beam envelope 120 having a nominal beam path 120A and containing at least one laser beam 120B during a welding operation that forms the weld 112. The ranging system 104 includes a ranging device 124 that comprises one or more ranging lasers 124L and one or more ranging sensors 124S for measuring one or more ranging distances, such as the ranging distance, RD, shown. The ranging system 104 also includes a coupling mechanism 128 that is configured with at least one degree of freedom that allows it to move the ranging device 124 repeatedly into and out of the welding-beam envelope 120. The coupling mechanism 128 moves the ranging device 124 into the welding-beam envelope 120 for taking one or more measurements of the ranging distance RD. Because the ranging device 124 takes measurements within the welding-beam envelope 120, the measurements can be highly precise and accurate for determining the welding location of the weld 112, as it is substantially positioned between the laser-welding tool 108 and the welding location along the path of the laser beam 120B that will be used to make the weld. When the laser-welding system 100 is making the weld 112 using the laser beam 120B, the coupling mechanism 128 moves the ranging device 124 out of the welding-beam envelope 120 so as to not block or otherwise interfere with the laser beam. FIG. 1 shows the ranging device 124 in each of a ranging position (lower and blocking the path of the laser beam 120B) and a welding position (upper and not blocking the path of the laser beam). Those skilled in the art will readily understand that the welding position shown in FIG. 1 is merely exemplary and that other welding positions can be used. Generally, the only requirement is that, during welding, no part of the ranging device 124 interferes with the welding beam 120B.

In an example, the coupling mechanism 128 may have a single linear or curvilinear degree of freedom for moving the ranging device 124 between its ranging and welding positions. Such linear degree of freedom may be provided to move the ranging device 124 parallel to the y-z plane shown, such as parallel along the z-axis, parallel along the y-axis or along any other direction(s) parallel to the y-z plane. The coupling mechanism 128 may include any suitable mechanism for providing this linear movement, such as a track-type mechanism or a linear actuator, among others. If a track-type mechanism is used, the track member(s) may be linear or curvilinear. In another example, the coupling mechanism may have a single rotational degree of freedom for moving the ranging device 124 between its ranging and welding positions. Such rotational degree of freedom may be provided to move the ranging device 124, for example, about an axis parallel to any one of the x-, y-, and z-axes shown, or any other suitable axis. The coupling mechanism 128 may include any suitable mechanism for providing this rotational movement, such as a stepper motor, a servo motor, or any other type of rotational actuator. In other examples, the coupling mechanism 128 may be configured to move the ranging device 124 between its ranging and welding positions using one or more mechanisms providing any two or more suitable degrees of freedom. All that is required is that the coupling mechanism 128 is able to move the ranging device 124 in a way to enable both ranging and welding and without interfering with any other aspect of the laser-welding system 100, and those skilled in the art will readily understand how to configure any suitable coupling mechanism to perform these functions. In some embodiments, the portion of the coupling mechanism 128 that moves the ranging device 124 between a welding position and a ranging position is referred to as a “shuttling mechanism” because of the reciprocating, or “shuttling,” nature of the movement, regardless of the character of the movement, i.e., regardless of the movement being rotational or translational.

The ranging device 124 includes at least one ranging laser 124L and at least one complementary ranging sensor 124S for making measurements of the ranging distance RD. Each of the ranging lasers 124L and each of the ranging sensors 124S may be, respectively, any suitable ranging laser and ranging sensor, including any commercial off-the-shelf ranging laser and ranging sensor, among others. Those skilled in the art will readily understand the types of ranging lasers and ranging sensors suitable for use with a ranging device of the present disclosure, such as the ranging device 124 of FIG. 1, such that further details need not be described herein for those skilled in the art to make and use a ranging system and a laser-welding system of the present disclosure, such as any of the ranging systems 104 and 204 and any of the laser-welding systems 100 and 200 of the present disclosure.

In some embodiments, the coupling mechanism 128 may include one or more degrees of freedom beyond the degree(s) of freedom provided for moving the ranging device between its ranging and welding positions. For example, the coupling mechanism 128 may be configured to provide a linear degree of freedom in a direction parallel to the x-axis shown. This degree of freedom may be provided, for example, to make fine-tuning adjustments along the nominal beam path 120A and/or to adjust the ranging system 104 to differing laser-tool focal lengths. As another example, the coupling mechanism 128 may have one or more additional degrees of freedom in a plane parallel to the y-z plane shown, for example, to make in-plane adjustments and/or, if multiple ranging lasers 124L and/or multiple ranging sensors 124S are provided, to deploy one or more other pairs or combinations of the ranging lasers and ranging sensors. Those skilled in the art will appreciate how to implement any such additional features.

In this example, the ranging system 104 includes a control system 132 that determines whether or not the focus spot of each laser beam 120B coincides with the location of the corresponding weld 112 within an acceptable tolerance, such as +/−1 mm, among other values. In some embodiments, the laser-welding system 100 may be configured to make any needed adjustment(s) to bring the focus spot of the laser beam 120B within the acceptable tolerance before the laser-welding tool 108 is energized to make the weld 112. For example, the laser-welding system 100 may include one or more controlled actuators, such as, for example, a servo-motor, a stepper motor, a linear actuator, etc., for moving the laser-welding tool 108 or the workpiece 116, or both the laser-welding tool and the workpiece until the focus spot would be acceptable for making the weld 112. In such embodiments, the control system 132 may use feedback control for operating the controlled actuator(s). Those skilled in the art will readily understand how to execute such feedback control within the control system 132 using only knowledge in the art and the present disclosure as a guide.

In some embodiments, the coupling mechanism 128 may be configured for only manual movement of the ranging device 124. In such embodiments, the control system 132 may include controls (not shown; e.g., soft or hard buttons, etc.) that allow a user to cause the ranging device 124 to take one or more measurements and include one or more indicators (not shown; e.g., graphical display, LED indicator, aural indicator, etc.) that indicate whether or not the focus spot of the laser beam 120B is within an acceptable tolerance.

In some embodiments, the control system 132 may additionally be configured to move the ranging device 124 between its ranging and welding position, for example, either automatically (e.g., in conjunction with automatic operation of the laser-welding tool 108) or semiautomatically (e.g., in response to a user inputting an appropriate “move” command). For example, the coupling mechanism 128 may include one or more controlled actuators 136, such as, for example, a servo-motor, a stepper motor, a linear actuator, etc., for moving the ranging device 124. In some embodiments, the movement of the ranging device between its ranging and welding positions may be manual and conducted by a user of the laser-welding system.

The control system 132 may comprise any suitable hardware and software for providing the requisite functionalities for the particular instantiation of the laser-welding system 100 at issue. Those skilled in the art will readily understand the types of hardware and software needed for the control system 132 provided to a particular instantiation and will further understand how to code any necessary machine-executable instructions for providing such functionalities. It is noted that although FIG. 1 depicts the control system 132 as being part of the ranging system 104, one or more, or all, aspects of the control system 132 may be provided outside the ranging system.

In some embodiments, one, the other, or both of the laser-welding tool 108 and the workpiece 116 may be fixed or movable. For example, in an example, the laser welding tool 108 is fixedly attached to a stationary structure (not shown), while the workpiece 116 is movable relative to the fixed laser welding tool, such as using a robotic manipulator (not shown) and/or other system, such as a conveyor system, among other. In some embodiments, a robotic manipulator may be used to properly position the workpiece 116 or an assembly of a workpiece and welding fixture relative to the laser-welding tool 108. Such positioning may include ensuring that that the ranging distance RD is proper for allowing the laser-welding tool 108 to form a quality weld upon the workpiece 116 in addition to gross movements of the workpiece or workpiece+welding fixture into and out of their welding position(s). As another example, the laser-welding tool 108 may be coupled to a fixed support (not shown) via an adjustment mechanism (not show) that moves the laser welding tool as needed to, for example, adjust the ranging distance RD and/or to make any other desired locational adjustments of the laser-welding tool. As a further example, both an adjustment mechanism for the laser-welding tool 108 and a robotic manipulator and/or other system for the workpiece or workpiece+welding fixture may be provided.

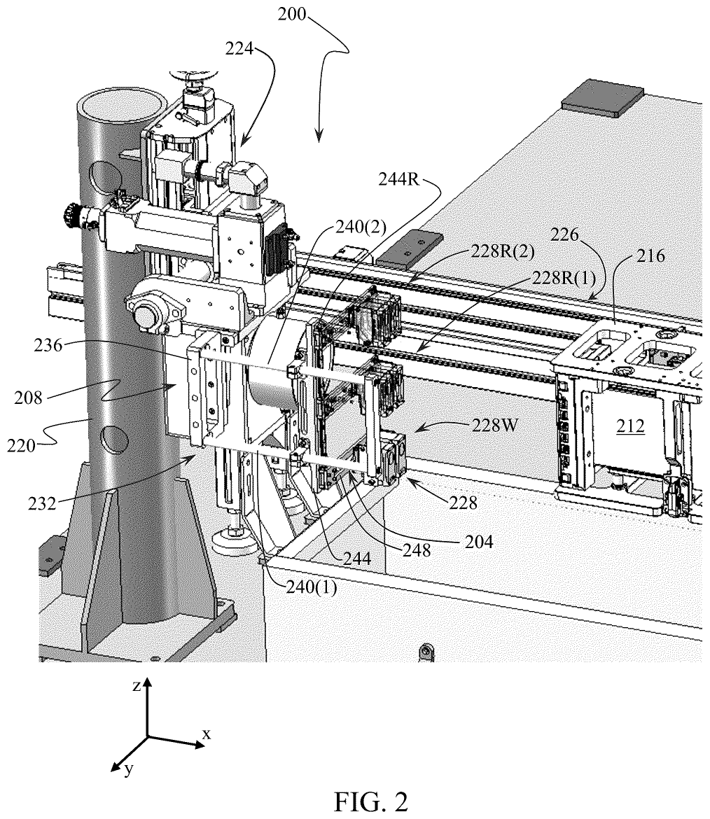

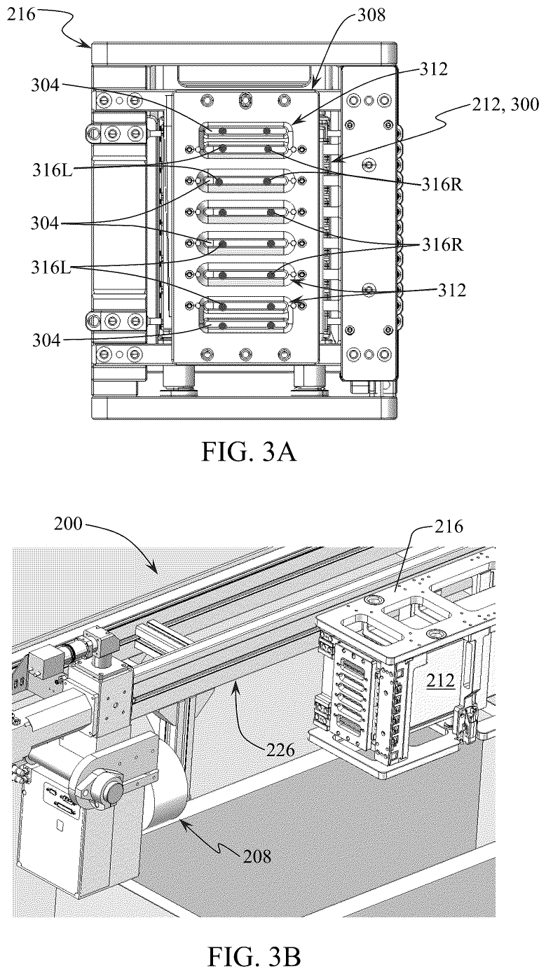

FIGS. 2 through 4 illustrate an example laser-welding system 200 having a manually operated ranging system 204 made in accordance with aspects of the present disclosure. In this example, the laser-welding system 200 includes a laser-welding tool 208 that is used for welding a workpiece 212, which in this example is firmly held in a welding fixture 216. FIG. 3A shows details of the workpiece 212 and welding fixture 216 pertinent to the example laser-welding system 200.

Referring to FIG. 3A, the workpiece 212 in this example is a secondary-battery core 300 composed of a stack of pouch-type electrochemical cells (not seen) (e.g., lithium-metal cells or lithium-ion cells, among many others) that have electrical tabs 304, immediately adjacent ones of which are bent so as to overlap one another. It is these bent and overlapped tabs 304 that the laser-welding system 200 of FIG. 2 electrically and physically connect together by welding on the faces of the tabs facing the viewer of FIG. 3A. The welding fixture 216 includes a front plate 308 that holds the overlapping tabs 304 in the proper position relative to one another for welding and has apertures 312 (only a few labeled to avoid cluttering the figure) through which a laser-welding beam (not shown) shines for creating the necessary welds (not shown). In this example, the ranging system 204 (FIG. 2) is designed and configured for measuring ranging distances (not shown, but see ranging distance RD of FIG. 1), at a set of inspection spots 316L (left) and 316R (right) (only a few of each labeled to avoid cluttering the figure) that correspond to locations on the tabs 304 where the laser-welding tool 208 (FIG. 2) will form welds. As those skilled in the art will readily appreciate, the workpiece 212 and welding fixture 216 in this example are merely illustrative and not limiting.

FIG. 3B shows the laser-welding system 200 without the ranging system 204 (FIG. 2) to show the relationship between the laser-welding tool 208 and the workpiece 212+welding fixture 216 more clearly. In this example, the laser-welding system 200 includes a conveyor 226 for delivering the welding fixture 216 and workpiece 212 to a location proximate to the welding position shown prior to welding operations and for receiving and moving the welding fixture+workpiece after the welding operations.

Although not shown, the welding system 200 may include a robotic manipulator having an end effector that engages the welding fixture 216. The robotic manipulator is configured and controlled to move the welding fixture 216 and the workpiece 212 held thereby, into and out of the its welding position and to and from other positions within the welding system. For example, prior to welding operations the robotic manipulator may be configured and controlled to pick the welding fixture 216 and workpiece 212 from the conveyor 226 prior to moving the welding fixture+workpiece into the welding position shown and then move the welding fixture+workpiece into the welding position. Then, following welding operations the robotic manipulator may be configured and controlled to move the welding fixture 216 and workpiece 212 from the welding position shown and place the welding fixture+workpiece back onto the conveyor 226. This is but one of many examples of moving the welding fixture 216 and workpiece 212 into and out of the welding location.

Referring again to FIG. 2, in this example the laser-welding tool 208 is movably mounted to a fixed support 220 via an adjustable mounting system 224 that provides three degrees of translational freedom parallel, respectively, the x-, y-, and z-axes shown. The adjustable mounting system 224 may be automatically and/or manually adjustable according to a design specification. The adjustable mounting system 224 may be used for any suitable purpose(s), such as adjusting distance between the laser-welding tool 208 and the workpiece 212 to set the focus spot of any relevant laser-welding beam and/or adjusting the location of the laser-welding tool to accommodate a laser-welding tool having a different focal length, among other things. Those skilled in the art will readily understand how to design, configure, and build the adjustable mounting system 224 to meet a corresponding design specification.

The ranging system 204 includes a ranging head 228 and a coupling mechanism 232 that in this embodiment couples the ranging head 228 to the laser-welding tool 208 and, in this example, allows the ranging head to move along three translational degrees of freedom parallel, respectively, to the x-, y-, and z-axes shown. In this example, the coupling mechanism 232 includes a mount 236, a pair of slide-rods 240(1) and 240(2), a multi-position bracket 244, and a device bracket 248. As seen in FIG. 2, the ranging head 228 is shown in three different non-simultaneous positions, namely, a welding position 228W, a first ranging position 228R(1), and a second ranging position 228R(2), as enabled by the coupling mechanism 232 as described below in detail. When the ranging head 228 is in each of the first and second ranging positions 228R(1) and 228R(2) (and in other ranging positions not illustrated), the ranging head is typically located at least partially within the beam envelope (not shown, but see beam envelope 120 of FIG. 1) of the laser-welding tool 208.

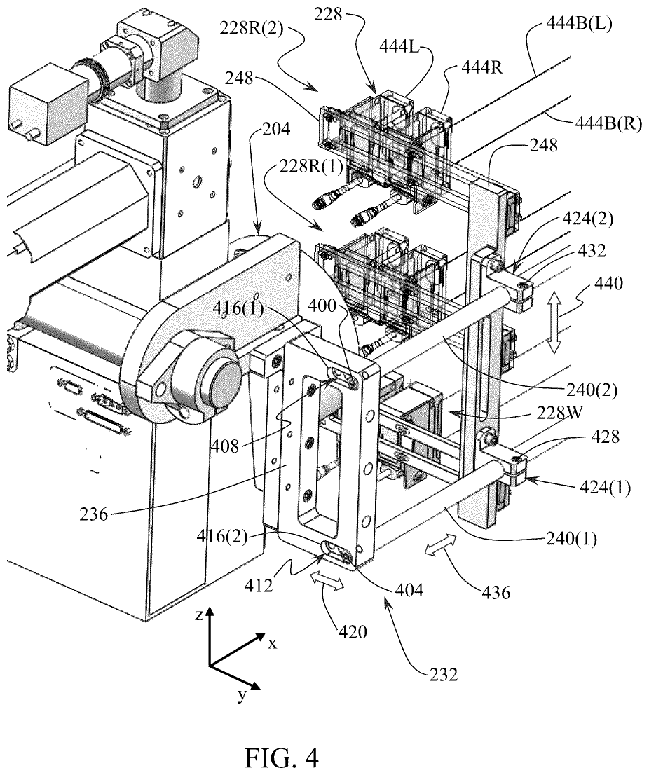

Referring to FIG. 4, in this example the mount 236 fixedly secures the coupling mechanism 232 to the laser-welding tool 208. The pair of slide-rods 240(1) and 240(2) are movably secured to the mount 236 via a pair of threaded fasteners 400 and 404, each of which can be installed in any one of three corresponding apertures 408 and 412 within a respective recess 416(1) and 416(2). Each set of apertures 408 and 412 provides the coupling mechanism 232 with adjustability in a direction parallel to the y-axis shown, as indicated by double-headed arrow 420. In this example, the adjustability of the coupling mechanism 232 in the direction of the double-headed arrow 420 is performed manually. In other embodiments, such adjustability may be performed automatically using one or more suitable actuators (not shown).

The multi-position bracket 244 is movably secured to the slide-rods 240(1) and 240(2) via a pair of slides 424(1) and 424(2) that can be locked into a fixed location via a corresponding locking screw 428, 432. The ability of the slides 424(1) and 424(2) to be moved along the slide-rods 240(1) and 240(2) provides the coupling mechanism 232 with adjustability in a direction parallel to the x-axis shown, as indicated by double-headed arrow 436. In this example, the adjustability of the coupling mechanism 232 in the direction of the double-headed arrow 436 is performed manually. In other embodiments, such adjustability may be performed automatically using one or more suitable actuators (not shown).

The device bracket 248 is movably secured to the multi-position bracket 244, such as via a slide rail 244R (FIG. 2) so as to provide the requisite movability to the ranging head 228 in a direction parallel to the z-axis shown in FIG. 4, as illustrated by double-headed arrow 440. The movability of the ranging head 228 in the direction of the double-headed arrow 440 is performed manually. In other embodiments, such adjustability may be performed automatically using one or more suitable actuators (not shown).

FIG. 4, like FIG. 2, shows the ranging head 228 (only labeled in the second ranging position 228R(2)) in each of the welding position 228W and the first and second ranging positions 228R(1) and 228R(2). In this example, the ranging head 228 includes a pair of laser-ranging devices 444L (left) and 444R (right) (only labeled in the second ranging position 228R(2)) that emit, respectively, ranging laser beams 444B(L) and 444B(R), which in this example, are used, respectively, for measuring ranging distances at inspection spots 316L and 316R of FIG. 3A.

In some aspects, the present disclosure is directed to a method of determining a ranging distance to a welding location for making a laser weld on a workpiece with a laser-welding beam having a beam path. The method includes moving a ranging device into the beam path; while the ranging device is in the beam path, operating the ranging device to acquire the ranging distance; and after acquiring the ranging distance, moving the ranging device out of the beam path.

In one or more embodiments of the method, moving the ranging device in and out of the beam path includes translating the ranging device within a plane perpendicular to the beam path.

In one or more embodiments of the method, moving the ranging device in and out of the beam path includes rotationally moving the ranging device.

In one or more embodiments of the method, the moving of the ranging device is performed automatically.

In one or more embodiments of the method, the moving of the ranging device is automatically coordinated with forming the laser weld.

In some aspects, the present disclosure is directed to a method of making a laser weld on a workpiece with a laser-welding beam having a beam path. The method includes moving a ranging device into the beam path; while the ranging device is in the beam path, operating the ranging device to acquire a ranging distance to a welding location on the workpiece; after acquiring the ranging distance, moving the ranging device out of the beam path; and after moving the ranging device out of the beam path, causing the laser-welding beam to make the laser weld on the workpiece.

In one or more embodiments of the method, moving the ranging device in and out of the beam path includes translating the ranging device within a plane perpendicular to the beam path.

In one or more embodiments of the method, moving the ranging device in and out of the beam path includes rotationally moving the ranging device.

In one or more embodiments of the method, the moving of the ranging device is performed automatically.

In one or more embodiments of the method, the moving of the ranging device is automatically coordinated with forming the laser weld.

In one or more embodiments of the method, determining a welding distance from a laser-welding tool to the welding location as a function of the ranging distance.

In one or more embodiments of the method, determining whether or not the welding distance is within a predetermined tolerance.

In one or more embodiments of the method, adjusting a welding distance between a laser-welding tool and the welding location based on the ranging distance.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A ranging system for use with a laser-welding tool that is used to make a weld on a workpiece at a welding location by emitting a welding beam along a beam path, the ranging system comprising:
a ranging device designed and configured to determine a ranging distance to the welding location when the ranging system is deployed and being used during welding operations; and
a coupling mechanism designed and configured to couple the ranging device in a fixed relationship relative to the laser-welding tool so that:
when the ranging device is determining the ranging distance, at least a portion of the ranging device is located in a ranging position in the beam path; and
when the laser-welding tool is emitting the welding beam so as to make the weld, the ranging device is located in a welding position out of the beam path.

2. The ranging system of claim 1, wherein the coupling mechanism includes a shuttling mechanism operatively coupled to the ranging device and configured to shuttle the ranging device between the welding and ranging positions.

3. The ranging system of claim 2, wherein the coupling mechanism includes a support for fixedly securing the coupling mechanism to the laser-welding tool, and the shuttling mechanism includes:
one or more guide rails fixedly secured to the support; and
a shuttle slidably engaged with the one or more guide rails, the ranging device being fixedly mounted to the shuttle;
wherein the one or more guide rails and the shuttle are designed and configured so that the shuttle is shuttleable along the one or more guide rails so as to move the ranging device between the welding and ranging positions.

4. The ranging system of claim 2, wherein the shuttling mechanism comprises a rotational axis about which the ranging device is pivoted when moving between the welding and ranging positions.

5. The ranging system of claim 2, wherein the shuttling mechanism includes an actuator coupled to the ranging device so as to shuttle the ranging device between the welding and ranging positions.

6. The ranging system of claim 5, further comprising a control system in operative communication with the actuator so as to cause the actuator to move the shuttle so as to move the ranging device between the welding and ranging positions.

7. The ranging system of claim 1, wherein the coupling mechanism further includes a first adjustment mechanism for adjusting a location of the ranging device relative to the laser-welding tool.

8. The ranging system of claim 1, further comprising a control system that uses the ranging distance to calculate a welding distance to a focus spot of the laser-welding beam.

9. The ranging system of claim 8, wherein the control system determines whether or not the welding distance is within a predetermined tolerance.

10. The ranging system of claim 9, wherein the control system outputs an indication of whether or not the welding distance is within the predetermined tolerance.

11. A laser-welding system, comprising:
a laser-welding tool that is used to make a weld on a workpiece at a welding location by emitting a welding beam along a beam path; and
a ranging system that includes:
a ranging device designed and configured to determine a ranging distance to the welding location when the ranging system is being used during welding operations; and
a coupling mechanism designed and configured to couple the ranging device in a fixed relationship relative to the laser-welding tool so that:
when the ranging device is determining the ranging distance, at least a portion of the ranging device is located in a ranging position in the beam path; and
when the laser-welding tool is emitting the welding beam so as to make the weld, the ranging device is located in a welding position out of the beam path.

12. The laser-welding system of claim 11, wherein the coupling mechanism includes a shuttling mechanism operatively coupled to the ranging device and configured to shuttle the ranging device between the welding and ranging positions.

13. The laser-welding system of claim 12, wherein the coupling mechanism includes a support for fixedly securing the coupling mechanism to the laser-welding tool, and the shuttling mechanism includes:
one or more guide rails fixedly secured to the support; and
a shuttle slidably engaged with the one or more guide rails, the ranging device being fixedly mounted to the shuttle;
wherein the one or more guide rails and the shuttle are designed and configured so that the shuttle is shuttleable along the one or more guide rails so as to move the ranging device between the welding and ranging positions.

14. The laser-welding system of claim 12, wherein the shuttling mechanism comprises a rotational axis about which the ranging device is pivoted when moving between the welding and ranging positions.

15. The laser-welding system of claim 12, wherein the shuttling mechanism includes an actuator coupled to the ranging device so as to shuttle the ranging device between the welding and ranging positions.

16. The laser-welding system of claim 15, further comprising a control system in operative communication with the actuator so as to cause the actuator to move the shuttle so as to move the ranging device between the welding and ranging positions.

17. The laser-welding system of claim 11, wherein the coupling mechanism further includes a first adjustment mechanism for adjusting a location of the ranging device relative to the laser-welding tool.

18. The laser-welding system of claim 11, further comprising a control system that uses the ranging distance to calculate a welding distance to a focus spot of the laser-welding beam.

19. The laser-welding system of claim 18, wherein the control system determines whether or not the welding distance is within a predetermined locational tolerance.

20. The laser-welding system of claim 19, wherein the control system outputs an indication of whether or not the welding distance is within the predetermined locational tolerance.

21. The laser-welding system of claim 19, further comprising at least one actuator for adjusting the welding distance, wherein the control system controls the at least one actuator so that the welding distance is within the predetermined locational tolerance.
